(19) United States
(12) Patent Application Publication
(10) Pub. No.: US 2019/0063689 A1
(43) Pub. Date: Feb. 28, 2019

(54) LEAK DETECTION DEVICE AND METHOD

(71) Applicant: Jinyu LIU, Qingdao (CN)

(72) Inventors: Jinyu LIU, Qingdao (CN); Diansheng WANG, Qingdao (CN); Yudou WANG, Qingdao (CN)

(73) Assignee: Jinyu LIU, Qingdao (CN)

(21) Appl. No.: 16/172,552

(22) Filed: Oct. 26, 2018

Related U.S. Application Data
(63) Continuation-in-part of application No. PCT/CN2016/092178, filed on Jul. 29, 2016.

(30) Foreign Application Priority Data
Apr. 29, 2016 (CN) 201610285055.0

(51) Int. Cl. F17D 3/01; F17D 5/02; G01M 3/28; F17D 5/00

(52) U.S. Cl. CPC F17D 3/01; F17D 5/02; F17C 13/04; F17D 5/005; G01M 3/2815

(57) ABSTRACT

The invention provides a device and a method for detecting a leak in a piping system. The device comprises a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the valve; and a controller employing a control logic. The controller comprises a central processing unit. Each of the shut-off valve, the flowmeter, the pressure decay detector is in communication with the controller. The control logic employed by the device and the method comprise that only after at least two consecutive pressure decay tests detect pressure drops in the conduit downstream of the shut-off valve while the shut-off valve is closed, it is ascertained the presence of a micro leak in the piping system.

This application claims the priority of WO 2017/185547, filed Jul. 29, 2016, which further claims the priority of Chinese patent application CN 105782728 A, filed on Apr. 29, 2016.

### FIELD OF THE INVENTION

The present invention generally relates to a device for detecting leaks in a piping system for conveying a fluid and automatically shutting off the fluid flow to the piping system if a leak is detected, and a method for detecting leaks in a piping system for conveying a fluid and automatically shutting off the fluid flow to the piping system if a leak is detected.

### BACKGROUND OF THE INVENTION

Leaks from water pipelines that can occur in a building, whether residential, commercial, or institutional, are highly undesirable. Over time, leaking water can be a significant and unnecessary expense. Moreover, water leakage from a broken or leaking water line can cause severe damage if left undetected for too long a period.

The prior art teaches numerous methods and devices for detecting a leak in a piping system and then automatically shutting off the supply to the piping system in order to minimize the waste and damage caused by the leak. However, heretofore the prior art approaches are generally insufficiently reliable, too complex, or too expensive to be effectively utilized in many applications. Accordingly, there is still a long felt need for improved approaches to detecting a leak in a piping system and then automatically shutting off the fluid supply to the piping system in order to minimize waste and damage caused by the leak.

### SUMMARY OF THE INVENTION

The present invention provides a device for detecting a leak in a piping system. The device comprises a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the shut-off valve; and a controller employing a control logic. The controller comprises a central processing unit. The controller may further comprise a communication module. Each of the shut-off valve, the flowmeter, the pressure decay detector is in communication with the controller. The control logic comprises: closing the shut-off valve and determining whether a first pressure drop is detected by the pressure decay detector; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether a second pressure drop is detected by the pressure decay detector; if the second pressure drop is detected, then ascertaining the presence of a micro leak in the piping system.

The invention also provides a method for detecting a leak in a piping system using a device that comprises a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the shut-off valve; and a controller that comprises a central processing unit and employs a control logic, each of the shut-off valve, the flowmeter, and the pressure decay detector being in communication with the controller. The method comprises employing the control logic by the controller of the device. The control logic comprises: closing the shut-off valve and determining whether a first pressure drop is detected by the pressure decay detector in a first pressure decay test; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether there is a second pressure drop detected by the pressure decay detector in a second pressure decay test; if the second pressure drop is detected, then ascertaining the presence of a micro leak in the piping system.

### BRIEF DESCRIPTION OF THE DRAWINGS

FIG. 1 shows an example of a device according to the present invention.

FIG. 2 shows another example of a device according to the present invention.

FIG. 3 shows an example of a control logic employed by the device of the invention.

### DETAILED DESCRIPTION OF THE INVENTION

In one aspect, the present invention provides a device for detecting a leak of a fluid in a piping system.

The device comprises a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the shut-off valve; a controller employing a control logic. The controller comprises a central processing unit. Each of the shut-off valve, the flowmeter, and the pressure decay detector is in communication with the controller.

The fluid can generally be any liquid or gas. Preferably, the fluid is a non-compressible liquid. In one example, the fluid is water. The device of the present invention is particularly suitable for a water line such as would be found delivering water to a residential home, a commercial building, or an institutional building. The pressure of a residential water supply line can generally be from about 0.1 to about 300 psi.

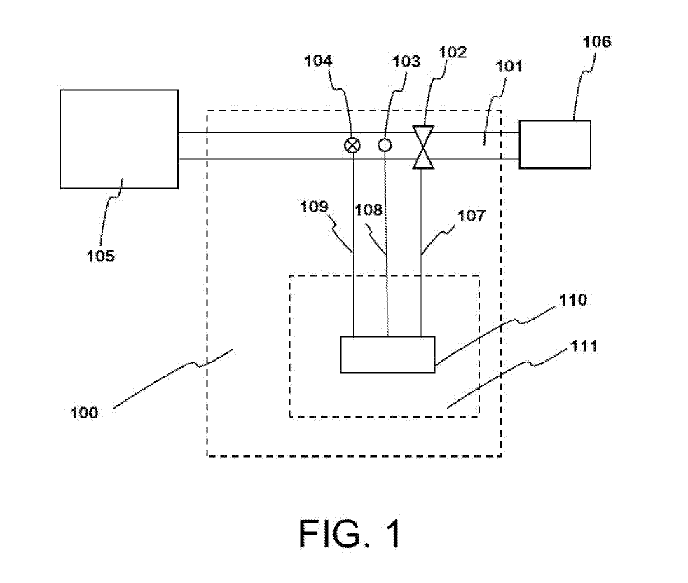

When used to detect a leak in a residential water piping system, the point of installation of the device of the present invention is typically between a supply source and the piping system, as shown in FIG. 1. The device of the invention can be installed right after any main water meter present or just after the point of entry into a home from a supply well pump. Generally, the device is installed in the main supply line to the piping system.

The shut-off valve is used to shut off the fluid supply to the piping system. When the shut-off valve is closed, no fluid can flow into the piping system from the supply. During normal use of the piping system by a user, the shut-off valve is open. Suitable shut-off valves for the present invention are known in industry, which can include, for example, electrically operated valves and solenoid valves. Preferred shut-off valves use electrical power to switch between “open” and “close” positions. Accordingly, preferred shut-off valves can automatically shut off the supply of fluid to the piping system if there is a power failure to the electrical power supply.

The shut-off valve is in communication with the controller via wired connection or via wireless communication techniques. The communication between the controller and the shut-off valve allows the controller to control the shut-off valve by opening or closing it at appropriate times.

The flowmeter is installed in the conduit and configured to measure a flow rate of the fluid in the conduit. Any conventional and reliable flowmeter of a type well known to those skilled in the art may be used. Desirably, the flowmeter is selected to reliably measure flow rates of about 10 Liter per hour (L/h), preferably about 5 L/h and is able to distinguish such flow rates from substantially zero flow. In one example, the flowmeter may measure fluid flow rate over the range of about 0.005 to about 50 L/h.

The flowmeter is in communication with the controller via wired connection or via wireless communication techniques. The communication between the flowmeter and the controller allows the controller to collect the measured flow rate data.

The pressure decay detector is installed in the conduit and configured to measure a pressure change of the fluid in the conduit downstream of the shut-off valve after the shut-off valve is closed. Generally the device of the invention measures or determines the pressure change, pressure decrease, or pressure decay after the shut-off valve is closed. Such an operation is hereinafter called “a pressure decay test.”

The pressure decay test is performed by first shutting off the supply of fluid into the piping system and then monitoring the pressure in the conduit connecting to the piping system to determine whether there is pressure decay. Once the supply of fluid to the piping system is shut off, no appreciable pressure decay should be detected unless a volume of fluid is removed from the piping system. However, removing even a small amount of fluid from the piping system, such as would occur if a leak is present, will cause a significant pressure decay in the piping system. A volume of fluid can be removed from the piping system either by a user demand or by a leak in the piping system.

The pressure decay detector may comprise a pressure sensor installed in the conduit downstream of the shut-off valve. A pressure sensor is used to measure the pressure of a fluid. Many suitable types of pressure sensors may be used, for example, a diffusion-silicon sensor.

The pressure decay detector may comprise a first pressure sensor installed in the conduit downstream of the shut-off valve and a second pressure sensor in the conduit upstream of the shut-off valve. In such a case, the pressure difference between the first pressure sensor and the second pressure sensor is determined. As the pressure of the fluid in the conduit upstream of the shut-off valve after the shut-off valve is closed remains more or less constant, the pressure difference between the first pressure sensor and the second pressure sensor can be used as an indication of the pressure change of the fluid in the conduit downstream of the shut-off valve. Alternatively, the pressure decay detector may comprise a differential pressure sensor, which monitors the difference between the pressure at the downstream of the shut-off valve and the pressure at the upstream of the shut-off valve in the conduit.

Since a pressure decay test requires the fluid supply to the piping system to be shut off during performance of the pressure decay test, the pressure decay test will disrupt normal use of the piping system if the pressure decay test is initiated during periods when there is a user demand. Therefore, the device of the present invention starts the pressure decay test when there is no user demand on the piping system. In this manner, the pressure decay test does not disrupt the normal use of the piping system. Accordingly, before a pressure decay test on a piping system is initiated by the device of the present invention, the piping system is first tested to determine if there is any user demand. If there is a user demand present, the pressure decay test is delayed until a later time when no user demand is detected. When no user demand is detected, the pressure decay test can be performed.

The pressure decay detector is in communication with the controller via wired connections or via wireless communication techniques. The communication between the controller and the pressure decay detector allows the controller to perform the pressure decay tests at appropriate times and transmit data to the controller at appropriate times.

There can be many possible methods for the device to detect the presence of a user demand. For example, in a residential water piping system, if the device detects a flow rate of greater than 0.5 L/h and no person is detected to be in the residence, then the device may decide that no user demand exists. On the other hand, if the device detects a flow rate of greater than 0.5 L/h and a person is detected to be in the residence, then the device may decide that a user demand exists. The detection of the presence of a person in a residence can be achieved by many commercially available instruments which can communicate the detection results to the device of the present invention via wired connections or via wireless communication techniques. In another example, equipment that uses water such as a dishwasher, a washing machine or others, and communicates wirelessly with the device of the present invention so that the device would have detected that a user demand is present when these equipment draws water from the piping system.

The device may be powered by plugging to an electrical outlet or a battery.

One illustrative example of the device of the present invention is shown in FIG. 1. The device 100 includes a conduit 101, a shut-off valve 102, a pressure sensor 103, a flowmeter 104, a controller 111, and a processor 110. The shut-off valve 102, pressure sensor 103, and flowmeter 104 are electronically connected to the controller by wires 107, 108, and 109 respectively. The device is installed between the fluid supply source 106 and a piping system 105. Additional valves may be used to connect the device to the fluid supply source 106 and the piping system 105.

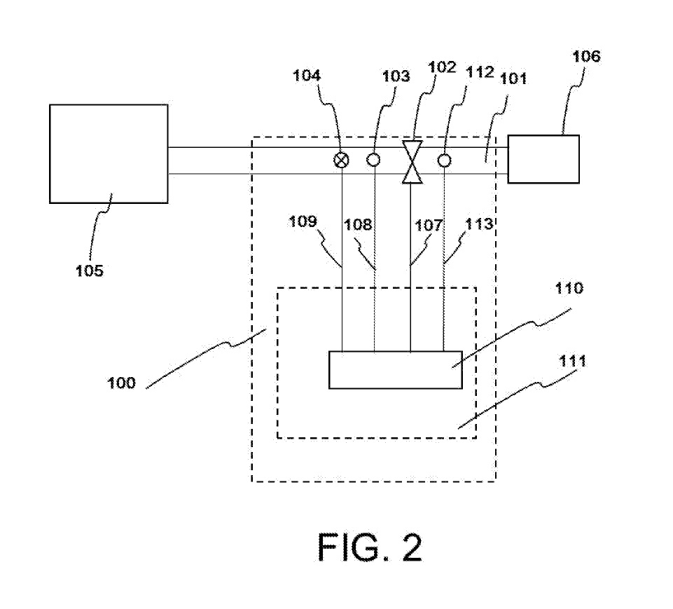

Another illustrative example of the device of the present invention is shown in FIG. 2. Compared to the device shown in FIG. 1, the device 100 in FIG. 2 includes a second pressure sensor 112 that is installed upstream of the shut-off valve 102. The pressure sensor 112 is connected to the controller by wire 113.

The control logic comprises: closing the shut-off valve and determining whether a first pressure drop is detected by the pressure decay detector in a first pressure decay test; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether a second pressure drop is detected by the pressure decay detector in a second pressure decay test; if the second pressure drop is detected, then ascertaining the presence of a micro leak in the piping system.

When the shut-off valve is closed to stop the fluid flow, a first pressure decay test is performed to determine whether there is a first pressure drop detected by the pressure decay detector.

If the first pressure drop is detected, then the shut-off valve is opened to measure the flow rate in the conduit to obtain a first measured flow rate. If the first measured flow rate is not less than a first preset flow rate and there is no user demand, then the device of the present invention ascertains the presence of a macro leak in the piping system. The first preset flow rate is generally set to be equal to the minimum fluid flow rate that the flowmeter can detect. Thus the first preset flow rate can depend on the sensitivity of the flowmeter employed. As an example, the first preset flow rate can be from about 0.001 to about 15 L/h, depending on the type of flowmeter used.

If the first measured flow rate is less than the first preset flow rate, the device measures the flow rate again to obtain a second measured flow rate after a first period of delay. The first period of delay can generally be between 2 seconds to several hours.

If the second measured flow rate is less than the second preset flow rate, then the shut-off valve is closed and the pressure drop detector performs a second pressure decay test to determine whether there is a second pressure drop detected by the pressure decay detector. The second preset flow rate can be set the same as the first preset flow rate or a different value. As an example, the second preset flow rate can be from about 0.001 to about 15 L/h.

If the second pressure drop is detected, then the device ascertains the presence of a micro leak in the piping system. A micro leak generally refers to a fluid leak of, for example, below about 15 L/h.

In order to reduce the chance of erroneous determination on the presence of a micro leak, the device of the present invention ascertains that there is the presence of a micro leak in the piping system only after at least two consecutive pressure decay tests determine that both the first pressure drop and the second pressure drop are detected, wherein there is a first period of delay between the two pressure decay tests.

If the first pressure drop is not detected, then the device reduces the frequency of micro leakage detection, thus reduces the power consumption by the device.

The control logic thus is characterized by that only after at least two consecutive pressure decay tests detect pressure drops in the conduit downstream of the shut-off valve after the shut-off valve is closed, it is ascertained the presence of a micro leak in the piping system.

The control logic of the device of the present invention may further comprise: if the first measured flow rate is not less than the first preset flow rate and there is a user demand, then measuring a single continuous flow duration or/and a single continuous flow fluid amount; if the single continuous flow duration is not less than a first preset duration or/and the single continuous flow fluid amount is not less than a first preset continuous flow fluid amount, then closing the shut-off valve and setting the alarm off; if the alarm is not cleared by a user, then opening the shut-off valve after a second period of delay and measuring the flow rate to obtain a third measured flow rate; if the third measured flow rate is not less than a third preset flow rate, then ascertaining the presence of a macro leak in the piping system.

If the first measured flow rate is not less than the first preset flow rate and there is no user demand detected, then the device ascertains the presence of macro leak in the piping system.

If the first measured flow rate is not less than a first preset flow rate and a user demand is detected, then the device measures a single continuous flow duration or/and a single continuous flow fluid amount. A single continuous flow duration refers to a time period of an uninterrupted fluid flow to the piping system, which can be measured by the controller. A single continuous flow fluid amount refers to the accumulative amount of fluid in volume or mass of an uninterrupted fluid flow to the piping system. The single continuous flow fluid amount can be obtained (calculated) from the fluid flow rates and the single continuous flow duration by the controller, for example, through integration calculation over the single continuous flow duration.

If the single continuous flow duration if measured is less than the first preset duration, and, the single continuous flow fluid amount if obtained (calculated) from the fluid flow rates and the single continuous flow duration is less than the first single continuous flow fluid preset amount, then the device determines that there is no further user demand. At this time, the device can initiate a pressure decay test by closing the shut-off valve.

If the single continuous flow duration is not less than the first preset duration, or/and, the single continuous flow fluid amount is not less than the first single continuous flow fluid preset amount, the device determines that there is a possibility of the presence of a macro leak in the piping system. At this time, the device will close the shut-off valve and set the alarm off. The first preset duration and the first single continuous flow fluid preset amount depend on the nature of the piping system and the user's specific needs. Generally, in a residential piping system, the first preset duration may be from about 2 to about 10 min; the first single continuous flow fluid preset amount may be from about 50 to about 100 L. In an industrial piping system, these preset values can be much greater. In a residential water piping system, a macro leak generally has a leak rate of greater than 0.5 L/h.

If the alarm is not cleared by the user, then the shut-off valve is opened after the second period of delay and the device measures the flow rate to obtain a third measured flow rate. The third preset flow rate can be set the same as the first preset flow rate or a different value. As an example, the third preset flow rate can be from 0.001 to 15 L/h.

If the third measured flow rate is less than the third preset flow rate, then the device closes the shut-off valve and moves to the step of measuring the first pressure drop.

If the third measured flow rate is not less than the third preset flow rate, then the device ascertains a presence of a macro leak in the piping system.

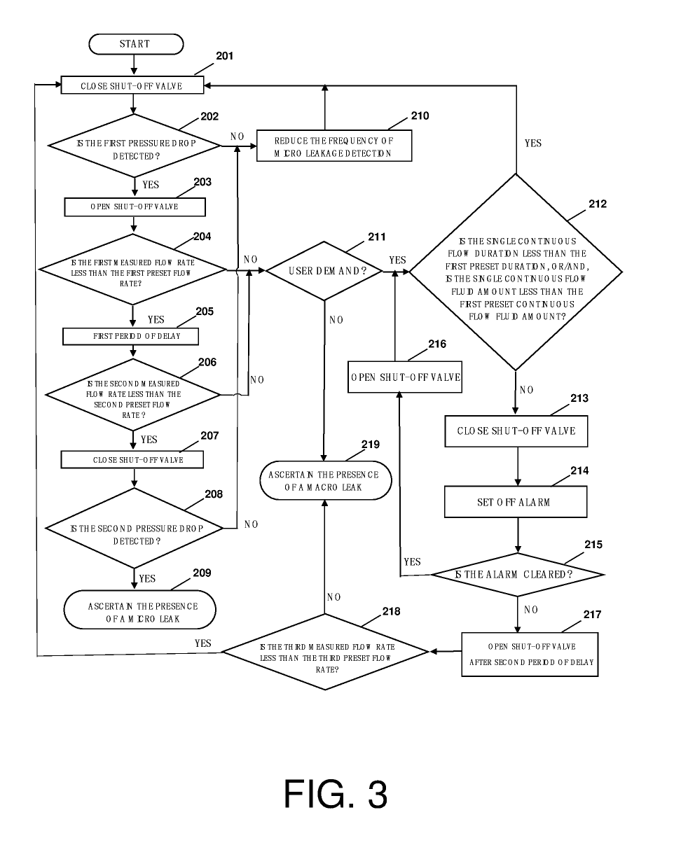

One example of the control logic suitable for the device of the present invention is shown in FIG. 3. When the device is initially installed, power is not supplied to the device and the shut-off valve remain closed as shown in step 201.

When power to the device is switched on, the device determines if the first pressure drop is detected in step 202. If the first pressure drop is detected, the shut-off valve is opened as shown in step 203. The device measures the flow rate in the conduit to obtain a first measured flow rate and determines if the first measured flow rate is less than the first preset flow rate in step 204. If the first measured flow rate is less than the first preset flow rate, the device then measures the flow rate again after a first period of delay (step 205) to obtain a second measured flow rate and to determine if the second measured flow rate is less than a second preset flow rate, as shown in step 206. If the second measured flow rate is less than the second preset flow rate, the device closes the shut-off valve (step 207) and performs a pressure decay test to determine if the second pressure drop is detected, as in step 208. If the second pressure drop is detected, the device ascertains the presence of a micro leak in the piping system, as shown in step 209.

In step 202, if the first pressure drop is not detected, the device will reduce the frequency of the micro leak detection (step 210). The micro leak detection includes steps 201, 202, 203, 204, 205, 206, 207, 208, and 209. Reducing the frequency of the micro leak detection can significantly reduce the power consumption by the device. If a battery is used to power the device, the battery life can be extended.

In step 204, if the first measured flow rate is not less than the first preset flow rate, the device then will determine if there is a user demand in the piping system (step 211).

In step 206, if the second measured flow rate is not less than the second preset flow rate, the device then will determine if there is a user demand in the piping system (step 211).

In step 208, if the second pressure drop is not detected, the device will reduce the frequency of the micro leak detection (step 210).

In step 211, if no user demand in the piping system is detected, the device ascertains that the macro leak is present in the piping system, as shown in step 219.

In step 211, if a user demand is detected, the device measures a single continuous flow duration or/and a single continuous flow fluid amount to determine if the single continuous flow duration is less than a first preset duration value, or/and, the single continuous flow fluid amount is less than a first preset continuous flow fluid amount value (step 212). If the single continuous flow duration if measured is less than the first preset duration, and, the single continuous flow fluid amount if obtained (calculated) from the fluid flow rates and the single continuous flow duration is less than a first preset continuous flow fluid amount, the device will go to step 201. If the single continuous flow duration is not less than the first preset duration, or/and, the single continuous flow fluid amount is not less than a first preset continuous flow fluid amount, the device will close the shut-off valve (step 213) and set the alarm off (step 214). If the alarm is not cleared by the user from step 215, the device opens the shut-off valve after a second period of delay (step 217) and measures the flow rate to obtain a third measured flow rate to determine if the third measured flow rate is less than a third preset flow rate (step 218). If the third measured flow rate is less than the third preset flow rate, then the control logic of the device goes to step 201. If the third measured flow rate is not less than the third preset flow rate, then the device ascertains the presence of macro leak in the piping system.

If the alarm is cleared by the user from step 215, then the control logic of the device opens the shut-off valve (step 216) and goes to step 212.

In another aspect, the invention provides a method for detecting a leak in a piping system using a device that comprises a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the shut-off valve; and a controller that comprises a central processing unit and employs a control logic, each of the shut-off valve, the flowmeter, and the pressure decay detector being in communication with the controller. The method comprises employing the control logic by the controller of the device. The control logic comprising: closing the shut-off valve and determining whether a first pressure drop is detected by the pressure decay detector in a first pressure decay test; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether there is a second pressure drop detected by the pressure decay detector in a second pressure decay test; if the second pressure drop is detected, then ascertaining the presence of a micro leak in the piping system. The control logic may further comprise: if the first measured flow rate is not less than the first preset flow rate and there is a user demand, then measuring a single continuous flow duration or/and a single continuous flow fluid amount; if the single continuous flow duration is not less than a first preset duration or/and the single continuous flow fluid amount is not less than a first preset continuous flow fluid amount, then closing the shut-off valve and setting the alarm off; if the alarm is not cleared by a user, then opening the shut-off valve after a second period of delay and measuring the flow rate to obtain a third measured flow rate; if the third measured flow rate is not less than a third preset flow rate, then ascertaining the presence of a macro leak in the piping system.

We claim:

1. A device for detecting a leak in a piping system, comprising:
a conduit for transporting a fluid;
a shut-off valve mounted onto the conduit;
a flowmeter installed in the conduit and configured to measure a flow rate of the fluid in the conduit;
a pressure decay detector configured to measure a pressure change of the fluid in the conduit downstream of the shut-off valve; and
a controller employing a control logic, the controller comprising a central processing unit,
wherein each of the shut-off valve, the flowmeter, and the pressure decay detector is in communication with the controller; and,
wherein the control logic comprises: closing the shut-off valve and determining whether a first pressure drop is detected by the pressure decay detector in a first pressure decay test; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether a second pressure drop is detected by the pressure decay detector in a second pressure decay test; if the second pressure drop is detected, then ascertaining the presence of a micro leak in the piping system.

2. The device of claim 1, wherein the control logic further comprises: if the first measured flow rate is not less than the first preset flow rate and there is a user demand, then measuring a single continuous flow duration or/and a single continuous flow fluid amount; if the single continuous flow duration is not less than a first preset duration or/and the single continuous flow fluid amount is not less than a first preset continuous flow fluid amount, then closing the shut-off valve and setting the alarm off; if the alarm is not cleared by a user, then opening the shut-off valve after a second period of delay and measuring the flow rate to obtain a third measured flow rate; if the third measured flow rate is not less than a third preset flow rate, then ascertaining the presence of a macro leak in the piping system.

3. The device of claim 1, wherein the pressure decay detector comprises a pressure sensor installed in the conduit downstream of the shut-off valve.

4. The device of claim 1, wherein the pressure decay detector comprises a first pressure sensor installed in the conduit downstream of the shut-off valve and a second pressure sensor installed in the conduit upstream of the shut-off valve.

5. A method for detecting a leak in a piping system by a device that comprises: a conduit for transporting a fluid; a shut-off valve mounted onto the conduit; a flowmeter installed in the conduit and configured to measure a flow rate of the fluid in the conduit; a pressure decay detector configured to measure a pressure change of the fluid in the conduit downstream of the shut-off valve; and a controller that comprises a central processing unit and employs a control logic, each of the shut-off valve, the flowmeter, and the pressure decay detector being in communication with the controller, the method comprising employing the control logic by the controller of the device, the control logic comprising: closing the shut-off valve and determine whether a first pressure drop is detected by the pressure decay detector in a first pressure decay test; if the first pressure drop is detected, then opening the shut-off valve to measure the flow rate in the conduit to obtain a first measured flow rate; if the first measured flow rate is not less than a first preset flow rate and there is no user demand, then ascertaining the presence of a macro leak in the piping system; if the first measured flow rate is less than the first preset flow rate, then measuring the flow rate again after a first period of delay to obtain a second measured flow rate; if the second measured flow rate is less than a second preset flow rate, then closing the shut-off valve and determining whether a second pressure drop is detected by the pressure decay detector in a second pressure decay test; if the second pressure drop is detected, then ascertaining the presence of a micro leak in the piping system.

6. The method of claim 5, wherein the control logic further comprises: if the first measured flow rate is not less than the first preset flow rate and there is a user demand, then measuring a single continuous flow duration or/and a single continuous flow fluid amount; if the single continuous flow duration is not less than a first preset duration or/and the single continuous flow fluid amount is not less than a first preset continuous flow fluid amount, then closing the shut-off valve and setting the alarm off; if the alarm is not cleared by a user, then opening the shut-off valve after a second period of delay and measuring the flow rate to obtain a third measured flow rate; if the third measured flow rate is not less than a third preset flow rate, then ascertaining the presence of a macro leak in the piping system.

7. The method of claim 6, wherein the fluid is a non-compressible liquid.

8. The method of claim 6, wherein the fluid is water.
